(19) United States
(12) Patent Application Publication
(10) Pub. No.: US 2023/0222221 A1
(43) Pub. Date: Jul. 13, 2023

(54) ATTACK CONTROL DEVICE, ATTACK CONTROL SYSTEM, AND COMPUTER PROGRAM PRODUCT

(71) Applicant: KABUSHIKI KAISHA TOSHIBA, Tokyo (JP)

(72) Inventors: Satoshi AOKI, Kawasaki Kanagawa (JP); Nakanishi FUKUTOMO, Sumida Tokyo (JP); Hiroyoshi HARUKI, Kawasaki Kanagawa (JP); Daiki ISHIHARA, Yokohama Kanagawa (JP)

(73) Assignee: KABUSHIKI KAISHA TOSHIBA, Tokyo (JP)

(21) Appl. No.: 17/899,140

(22) Filed: Aug. 30, 2022

(30) Foreign Application Priority Data
Jan. 7, 2022 (JP) 2022-001669

(51) Int. Cl. G06F 21/57

(52) U.S. Cl. CPC G06F 21/577; G06F 2221/034

(57) ABSTRACT

According to an embodiment, an attack control device includes a detection unit, an attack result storage control unit, an attack result analysis unit, and an attack instruction unit. The detection unit analyzes an attack result of a multi-stage attack executed based on an attack scenario and detects a failed attack instruction that has failed because of a session interrupted during the multi-stage attack. The attack result storage control unit stores the attack result in a storage device. The attack result analysis unit analyzes an attack instruction that has established the interrupted session from the attack result. The attack instruction unit resumes the multi-stage attack from the attack instruction that has established the interrupted session.

### CROSS-REFERENCE TO RELATED APPLICATIONS

This application is based upon and claims the benefit of priority from Japanese Patent Application No. 2022-001669, filed on Jan. 7, 2022; the entire contents of which are incorporated herein by reference.

### FIELD

Embodiments described herein relate generally, to an attack control device, an attack control system, and a computer program product.

### BACKGROUND

As a method of verifying security of a system, a technique to assess vulnerability and security risks in the system from an attacker's viewpoint has been previously known (for example, penetration test and the like). By voluntarily attempting a cyber attack before actually being damaged by an attacker's cyber attack, remaining vulnerability and security risks can be determined in advance and used as a material for consideration to take countermeasures.

### BRIEF DESCRIPTION OF THE DRAWINGS

FIG. 1 is a diagram illustrating an example of a device configuration of an attack control system of a first embodiment;

FIG. 2 is a diagram illustrating an example of a functional configuration of an attack control device of the first embodiment;

FIG. 3 is a diagram illustrating an example of an attack scenario of the first embodiment;

FIG. 4 is a diagram illustrating an example of an attack result group of the first embodiment;

FIG. 5 is a diagram illustrating an example of session information of the first embodiment;

FIG. 6 is a flowchart illustrating an example of an attack control method of the first embodiment;

FIG. 7 is a diagram illustrating an example of a functional configuration of an attack control device of a second embodiment;

FIG. 8A is a diagram illustrating an example of a second attack scenario of the second embodiment;

FIG. 8B is a diagram illustrating an example of an attack instruction group of the second embodiment;

FIG. 9 is a flowchart illustrating an example of an attack control method of the second embodiment;

FIG. 10 is a diagram illustrating an example of a device configuration of a third embodiment;

FIG. 11 is a diagram illustrating an example of a functional configuration of an attack control device of the third embodiment;

FIG. 12 is a flowchart illustrating an example of an attack control method of the third embodiment; and

FIG. 13 is a diagram illustrating an example of a hardware configuration of the attack control device of the first to third embodiments.

### DETAILED DESCRIPTION

According to an embodiment, an attack control device includes a detection unit, an attack result storage control unit, an attack result analysis unit, and an attack instruction unit. The detection unit analyzes an attack result of a multi-stage attack executed based on an attack scenario and detects a failed attack instruction that has failed because of a session interrupted during the multi-stage attack. The attack result storage control unit stores the attack result in a storage device. The attack result analysis unit analyzes an attack instruction that has established the interrupted session from the attack result. The attack instruction unit resumes the multi-stage attack from the attack instruction that has established the interrupted session.

Embodiments of an attack control device, an attack control system, and a program will be described in detail below with reference to the accompanying drawings.

For example, a penetration test is executed by a security expert having knowledge, skill, and the like from the attacker's viewpoint. Attack paths and scenarios for achieving a predetermined attack goal are manually created by the security expert having knowledge, skill, and the like from the attacker's viewpoint. Therefore, the quality of the penetration test often depends on the knowledge, skill, and the like of the penetration tester.

The existing penetration test analyzes a cause of an attack failure, and in a case where the attack failure is caused by disconnection of a session used for the attack, the disconnected session needs to be established again and the attack needs to be re-executed. When doing the penetration test manually, there is a problem that work man-hours are used for the analysis of the cause of attack failure and re-execution of the attack.

### First Embodiment

To begin with, an example of a device configuration of an attack control system of a first embodiment will be described.

### Example of Device Configuration

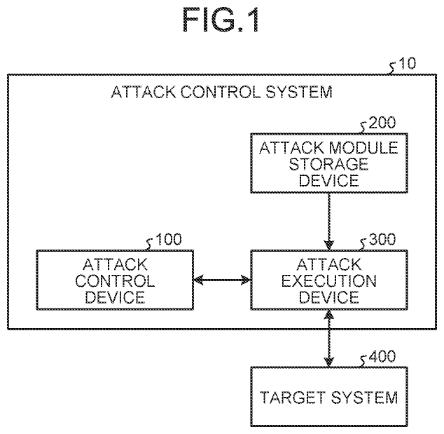

FIG. 1 is a diagram illustrating an example of a device configuration of an attack control system 10 of the first embodiment. The attack control system 10 of the first embodiment includes an attack control device 100, an attack module storage device 200, and an attack execution device 300.

The attack control device 100 transmits an attack instruction to the attack execution device 300 and receives an attack result from the attack execution device 300.

The attack module storage device 200 stores an attack module. The attack module of the first embodiment is stored, for example, in an attack module database of the attack module storage device 200.

The attack execution device 300 reads the attack module designated by the attack instruction from the attack module storage device 200, executes an attack on a target system 400, which is an attack target, and outputs the attack result.

Note that the attack execution device 300 may be a device integrated with the attack module storage device 200. For example, the attack execution device 300 may be a device having a penetration test tool such as Metasploit. For example, the attack execution device 300 may be a device that executes a script for penetration test, such as a Python script, a PowerShell script, and a Ruby script.

### Example of Functional Configuration

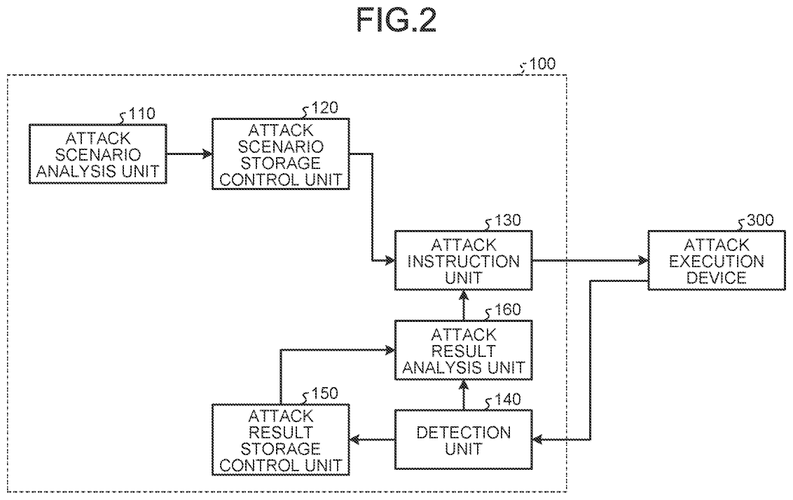

FIG. 2 is a diagram illustrating an example of a functional configuration of the attack control device 100 of the first embodiment. The attack control device 100 of the first embodiment includes an attack scenario analysis unit 110, an attack scenario storage control unit 120, an attack instruction unit 130, a detection unit 140, an attack result storage control unit 150, and an attack result analysis unit 160.

The attack scenario analysis unit 110 acquires at least one attack scenario and analyzes the attack scenario. An attack scenario 500 may be, for example, a JSON format and XML format.

### Example of Attack Scenario

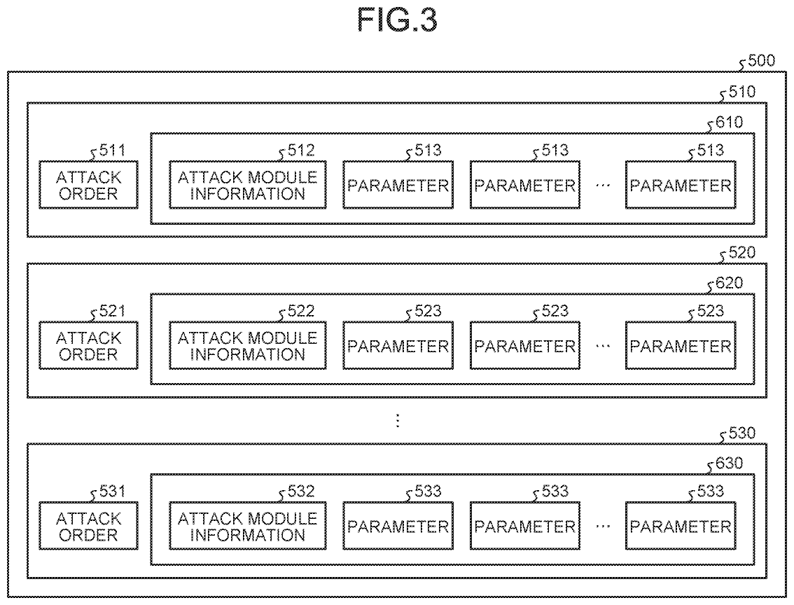

FIG. 3 is a diagram illustrating an example of the attack scenario 500 of the first embodiment. The attack scenario 500 of the first embodiment includes a plurality of attacks 510, 520, and 530. Since the descriptions of the attacks 510, 520, and 530 are similar to each other, the description mainly takes the attack 510 as an example.

The attack 510 includes an attack order 511 and an attack instruction 610. The attack instruction 610 includes attack module information 512 and parameters 513.

The attack order 511 indicates the order of the attack instruction 610 to be executed. In the first embodiment, the attack order 511 represents dependence between the attack instructions 610, 620, and 630. For example, dependence such that the attack 520 of the attack order 521 after the attack order 511 does not succeed unless the attack 510 of the attack order 511 succeeds is indicated. Similarly, to execute the attack 530, the attacks 510 and 520 need to be success.

The attack module information 512 is information indicating the attack module used for an attack by the attack execution device 300. For example, the attack module information 512 is a file name, a file path, or the like of the attack module.

The parameter 513 is a parameter of the attack module designated by the attack module information 512. A plurality of parameters 513 may be included as illustrated in FIG. 3, or one parameter 513 may be included. The parameter 513 indicates, for example, an IP address, a port number, a user name, a password, a payload module, a session ID, a type of attack target, and the like.

Note that the attack instruction 610 may not include the parameter 513. If the attack instruction 610 does not include the parameter 513, for example, the attack scenario analysis unit 110 may receive input of the parameter 513 from a user. For example, the attack scenario analysis unit 110 may not set the parameters 513, 523, and 533 for the attack instructions 610, 620, and 630, respectively, but the attack instructions 610, 620, and 630 may have a unified parameter list as a whole.

Note that a method may be used in which the attack scenario 500 does not include the attack order 511, 521, and 531, and an attack is made in the order in which the attacks 510, 520, and 530 are described.

The dependence between the plurality of attacks is not limited to the attack order, but may be represented in a tree format or a state transition diagram indicating the relationship between individual attacks, or may be represented as preconditions and effects (state change after the attack) for each attack, like goal-oriented action planning (GOAP).

Returning to FIG. 2, the attack scenario storage control unit 120 stores the above-described attack scenario 500 (see FIG. 3) in a storage device. The storage device that stores the attack scenario 500 may be built in the attack control device 100 or may be outside the attack control device 100.

The attack instruction unit 130 transmits the attack instructions 610, 620, and 630 to the attack execution device 300 in order according to the attack order 511, 521, and 531 of the attack scenario 500. The attack instructions 610, 620, and 630 need to be attack in compatible with the attack execution device 300. Specifically, each attack module designated by the attack instructions 610, 620, and 630 needs to be an attack module that can be referenced from the attack module database loaded into the attack execution device 300. In the parameters 513, 523, and 533, information necessary for executing the attack module needs to be designated.

The detection unit 140 acquires an attack result group from the attack execution device 300, and detects an attack failure caused by a session interruption that occurs in the multi-stage attack (plurality of attacks executed in order).

### Example of Attack Result Group

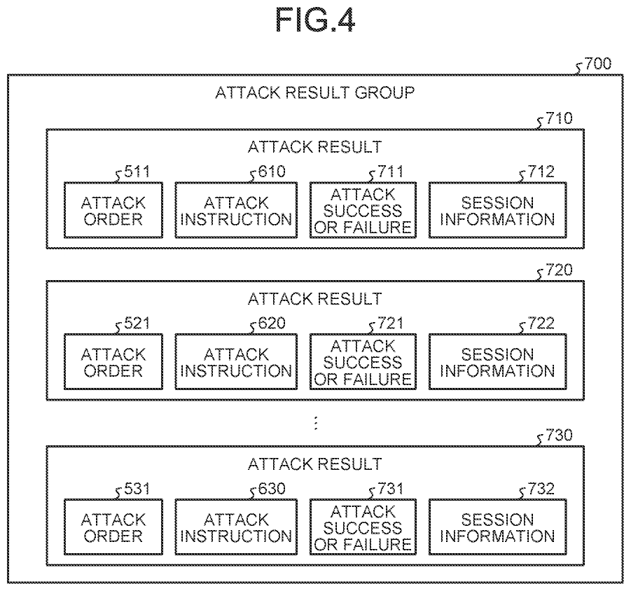

FIG. 4 is a diagram illustrating an example of an attack result group 700 of the first embodiment. The attack result group 700 includes an attack result of at least one attack executed by the attack execution device 300. In the example of FIG. 4, the attack result group 700 includes attack results 710, 720, and 730 generated for the attacks 510, 520, and 530, respectively. Since the descriptions of the attack results 710, 720, and 730 are similar to each other, the attack result 710 will be mainly described as an example.

The attack result 710 includes the attack order 511, the attack instruction 610, attack success or failure 711, and session information 712.

The attack order 511 and the attack instruction 610 are similar to those in FIG. 3.

Since the attack result 710 includes the attack order 511, it will be easier to analyze in which stage the multi-stage attack has failed, and when re-executing the attack, it is possible to create an attack procedure that takes the attack order into consideration.

The attack instruction 610 is an instruction transmitted from the attack instruction unit 130 and executed by the attack execution device 300.

The attack success or failure 711 is information indicating success or failure of the attack by the attack instruction 610. The attack success or failure 711 may include an attack execution log, an attack failure cause, and the like as auxiliary information. The auxiliary information makes it easier to detect the cause of the attack failure. The cause of the attack failure is, for example, the interruption of the session established by the attack in the previous stage.

The session information 712 indicates information on the session established with the target system 400 by the attack execution device 300. The session information 712 is information on the session used when executing the attack instruction 610, or information on the session established after executing the attack instruction 610. The session information 712 may include only one piece of session information or both pieces of session information.

### Example of Session Information

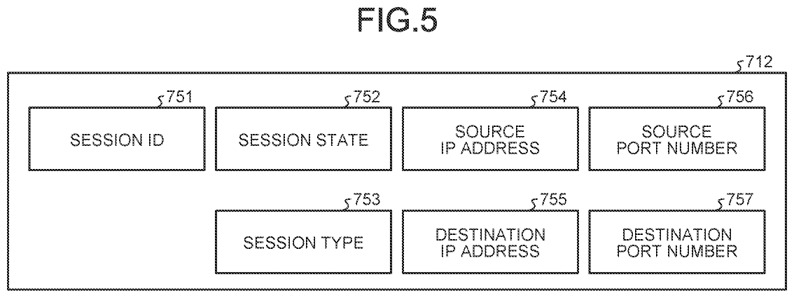

FIG. 5 is a diagram illustrating an example of the session information 712 of the first embodiment. The session information 712 of the first embodiment includes a session ID 751, a session state 752, a session type 753, a source IP address 754, a source port number 755, a destination IP address 756, a destination port number 757, and the like.

The session TD 751 is identification information for identifying the session. For example, the session ID 751 may be an identification number assigned to manage the session by the attack execution device 300. When the session ID 751 is an identification number, the session ID 751 can be set as one of the parameters 513 included in the attack instruction 610.

The session state 752 indicates a state of the session (for example, connected or disconnected).

The session type 753 indicates the type of session. The type of session is, for example, the type of execution permission in the target system 400 (for example, the presence or absence of administrative privileges).

The source IP address 754 indicates an IP address of the connection source device of the session. The source port number 755 indicates a port number of the connection source device of the session. The destination IP address 756 indicates an IP address of the connection destination device of the session. The destination port number 757 indicates a port number of the connection destination device of the session.

Returning to FIG, 2, the attack result storage control unit 150 stores the attack results 710, 720, and 730 in the storage device. The storage device that stores the attack results 710, 720, and 730 may be built in the attack control device 100 or may be outside the attack control device 100.

For example, since the attack result storage control unit 150 stores the plurality of attack results (attack results 710, 720, and 730 in the example of FIG. 4), it is possible to determine the attack success or failure of each attack (attacks 510, 520, and 530 in the example of FIG. 2). Specifically, it will be easier for a tester who uses the attack control system 10 to organize the attack result into a report after executing the test.

The attack result analysis unit 160 analyzes the attack to be executed next based on the attack result. For example, when the detection unit 140 detects that the attack has failed because of the interruption of the session established during the attack executed by the attack execution device 300, the attack result analysis unit 160 transmits the attack instruction back to the attack that has established the interrupted session to the attack instruction unit 130. The attack instruction going back to the attack that has established the interrupted session is determined, for example, based on the dependence between the attacks.

For example, the attack result analysis unit 160 refers to the success or failure of the attack stored in the storage device, traces back the attack included in the multi-stage attack, and analyzes the attack once successful. This allows the attack instruction unit 130 to instruct the once successful attack with priority.

For example, the attack result analysis unit 160 analyzes the attack instruction that is more likely to succeed based on the success or failure of the attack instruction. Then, the attack instruction unit 130 instructs the attack by preferentially using the attack scenario including the attack instruction is more likely to succeed, more.

For example, the attack result analysis unit 160 analyzes the attack instruction that is less likely to fail because of the session based on the failed attack instruction that has failed because of the session that has been interrupted during the multi-stage attack. Then, the attack instruction unit 130 instructs the attack by preferentially using the attack scenario including the attack instruction likely to fail because of the session, more.

When a plurality of attack scenarios 500 exists, it is possible to perform a penetration test in consideration of time, man-hours, and the like by prioritizing the attack scenarios 500. Specifically, when a large number of attack scenarios 500 exist, for example, only the attack scenario whose priority is higher than a threshold can be executed.

### Example of Attack Control Method

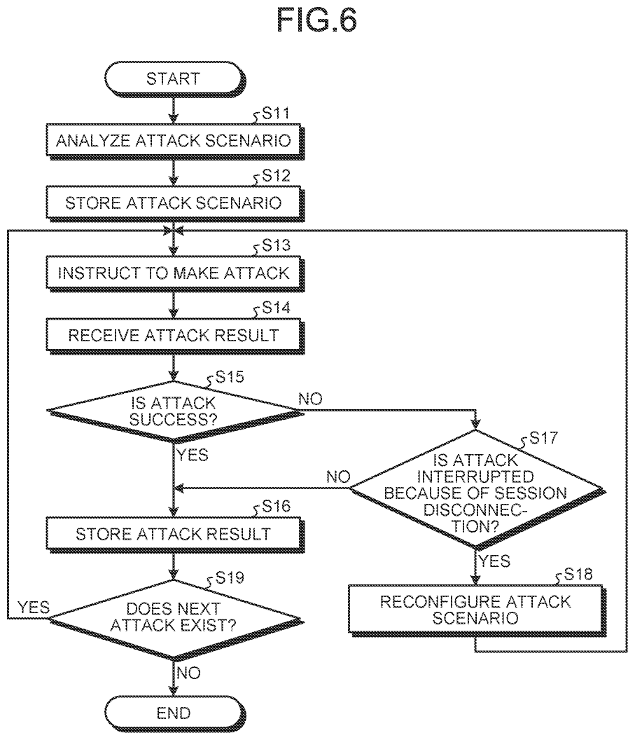

FIG. 6 is a flowchart illustrating an example of an attack control method of the first embodiment. To begin with, the attack scenario analysis unit 110 acquires the above-described attack scenario 500 and analyzes the attack scenario 500 (step S11).

Next, the attack scenario storage control unit 120 stores the attack scenario 500 analyzed in step S11 in the storage device (step S12). Even if a plurality of attack scenarios 500 exists, by storing the attack scenarios 500 in the storage device, the attack instruction unit 130 can execute the attack scenarios 500 again, or execute the plurality of attack scenarios 500 in succession.

Next, the attack instruction unit 130 instructs the attack execution device 300 to make an attack (step S13).

The attack instructions 610, 620, and 630 to be transmitted to the attack execution device 300 are transmitted in the attack order 512, 522, and 532 of the attack scenario 500. When transmitting the attack instructions 610, 620, and 630, one attack instruction 610, 620, or 630 may be transmitted at a time, or a plurality of attack instructions 610, 620, and 630 may be transmitted at a time.

When one attack instruction 610, 620, or 630 is transmitted at a time, it is possible to acquire the attack result 710, 720, or 730 each time, making it easier to investigate the cause of the attack failure. When the plurality of attack instructions 610, 620, and 630 are transmitted at a time, there is no time to wait for the next attack instruction, making it possible to shorten the time to finish the execution of the attack scenario 500.

When there is already a session available for the attack interrupted because of the session disconnection, such as after the transition from step S18 to step S13, the attack instruction unit 130 may use the session when making an attack again. Specifically, in the example of FIG. 4, the attack instruction unit 130 refers to the correspondence between the session information 712, 722, and 732 and the attack instructions 610, 620, and 630 included in the attack result group 700. It is assumed that when the attack instruction unit 130 executes the attack scenario 500 for the first time, the session established by the attack instruction 620 is disconnected while the attack instruction 630 is executed and the attack instruction 630 has failed. At this time, when executing the attack scenario 500 for the second time, the attack instruction unit 130 does not execute the attack instruction 610 again, but executes the attack instruction 620 again by using the session already established by the attack instruction 610 of the attack scenario 500 for the first time.

Next, the detection unit 140 receives the attack result group 700 from the attack execution device 300 (step S14).

Next, the detection unit 140 determines whether all the attacks 510, 520, and 530 are success from the attack success or failure 711, 721, and 731 of the attack result group 700 received in step S14 (FIG. 3, step S15).

When all the attacks 510, 520, and 530 are success (step S15, Yes), the attack result storage control unit 150 stores the attack results 710, 720, and 730 included in the attack result group 700 in the storage device (step S16).

Note that the attack result storage control unit 150 may store the attack result in the storage device regardless of whether the attack is success or failure. The attack result storage control unit 150 stores the attack result when the attack fails in the storage device, thereby making it possible to interrupt the execution of the attack scenario 500 when the number of failed attacks exceeds a threshold, and to prevent the execution time of the attack scenario 500 from becoming long because of repeated attack failure. Note that the threshold may be arbitrarily set by a user such as a tester. Specifically, the number of failed attacks is, for example, the number of times the failed attack instruction that has failed because of the session interrupted during the multi-stage attack is detected. For example, when the number of times the failed attack instruction is detected is larger than the threshold, the attack instruction unit 130 instructs the attack based on the attack scenario that does not include the failed attack instruction.

The attack result storage control unit 150 stores the attack success or failure 711, 721, and 731 in the storage device, thereby allowing the attack instruction unit 130 to determine the attack instruction that has been successful. With this configuration, for example, when the attack instruction unit 130 executes the plurality of attack scenarios 500, in a case where the attack instruction that has been successful fails, control such as invalidating the above-described threshold and executing the attack again becomes possible.

The attack result storage control unit 150 may store supplementary information on the attack results 710, 720, and 730 in the storage device. For example, the supplementary information includes information indicating whether the failure is caused by the session interruption. For example, the supplementary information includes the number of failed attacks. Since the attack result storage control unit 150 stores the supplementary information for determining the attack that is likely to be interrupted (fail) in the storage device, the attack instruction unit 130 can execute with priority the attack that is unlikely to be interrupted when the attack is executed again, and can additionally make an attack instruction to make the session less likely to be interrupted (attack to combine the established session into another process).

Next, the attack instruction unit 130 refers to the attack scenario 500 to determine whether the next attack exists (step S19). Specifically, the attack instruction unit 130 determines whether the attack instruction that has a previous attack order is successful and has not been transmitted to the attack execution device 300 exists.

When the next attack exists (step S19, Yes), the process proceeds to step S13, and when the next attack does not exist (step S19, No), the process ends.

When a plurality of attack scenarios 500 exists, the attack scenario 500 that has not been executed yet may be read from the storage device and the process may proceed to step S13.

When any of the attacks 510, 520, and 530 fails (step S15, No), the detection unit 140 determines whether the attack has failed because the session has been disconnected during the attack (step S17).

The attack results 710, 720, and 730 include the session information 712, 722, and 732 after the attack instructions 610, 620, and 630 are executed. For example, by comparing the session information 722 of the attack instruction 620 with the session information 712 of the attack instruction 610 before the attack instruction 620, the detection unit 140 can detect the session established and the session disconnected when the attack instruction 620 is executed.

The detection unit 140 refers to the attack success or failure 711, 721, and 731 to search for the attack instruction with the failed attack, and in a case where there is a session that was disconnected when the attack instruction was executed, the detection unit 140 determines that the attack has been interrupted because of the session disconnection and notifies the attack result analysis unit 160.

When the attack is not interrupted because of the session disconnection (step S17, No), the process proceeds to step S16.

When the attack is interrupted because of the session disconnection (step S17, Yes), the attack result analysis unit 160 reconfigures the attack scenario 500 to go back to the attack that has established the session required to execute the interrupted attack and make the attack (step S18). The attack scenario 500 reconfigured in step S18 is transmitted to the attack instruction unit 130, and the process of step S13 is executed again. For example, in a case where it is determined that the attack of the attack instruction 630 has failed because of disconnection of the session established by the attack instruction 620 while the attack instruction 630 is executed, when the session established by the attack instruction 610 remains established, the attack result analysis unit 160 reconfigures the attack scenario 500 excluding the attack instruction 610. When the session established by the attack instruction 610 is also in a disconnected state, the attack result analysis unit 160 reconfigures the attack scenario 500 still including all The attack instructions 610, 620, and 630.

As described above, in the attack control device 100 of the first embodiment, the detection unit 140 analyzes the attack result of the multi-stage attack executed based on the attack scenario 500, and detects the failed attack instruction that has failed because of the session interrupted during the multi-stage attack. The attack result storage control unit 150 stores the attack result in the storage device. The attack result analysis unit 160 analyzes the attack instruction that has established the interrupted session from the attack result. Then, the attack instruction unit 130 resumes the multi-stage attack from the attack instruction that has established the interrupted session.

This allows the attack control device 100 of the first embodiment to shorten the time required for the test to detect vulnerability and improve detection accuracy.

For example, because the session used for the attack is managed, the attack control device 100 of the first embodiment can, for example, automate part of the penetration test. This makes it possible to shorten the penetration test time and implement a uniform test that does not require a skilled tester.

For example, it is possible to prevent false negatives. False negatives mean incorrectly classifying security risk as no risk.

As described above, the attack control device 100 of the first embodiment can achieve improvement in security of the target system 400.

### Second Embodiment

Next, a second embodiment will be described. In the description of the second embodiment, the description similar to the first embodiment will be omitted, and parts different from the first embodiment will be described.

### Example of Functional Configuration

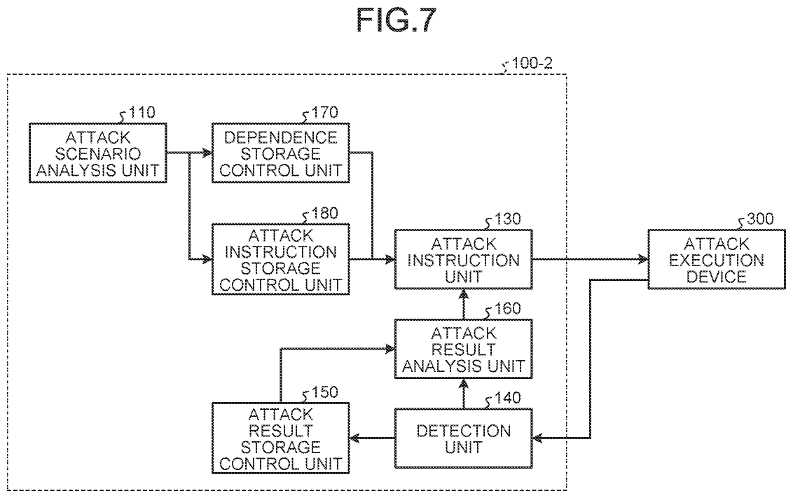

FIG. 7 is a diagram illustrating an example of a functional configuration of an attack control device 100-2 of the first embodiment. The attack control device 100-2 of the first embodiment includes an attack scenario analysis unit 110, an attack instruction unit 130, a detection unit 140, an attack result storage control unit 150, an attack result analysis unit 160, a dependence storage control unit 170, and an attack instruction storage control unit 180.

The attack scenario analysis unit 110, the attack instruction unit 130, the detection unit 140, the attack result storage control unit 150, and the attack result analysis unit 160 are similar to those in the first embodiment, and thus the description thereof will be omitted.

The dependence storage control unit 170 stores dependence between attacks 510, 520, and 530 included in an attack scenario 500 in a storage device as a second attack scenario.

The attack instruction storage control unit 180 stores attack instructions 610, 620, and 630 included in the attack scenario 500 in the storage device as an attack instruction group.

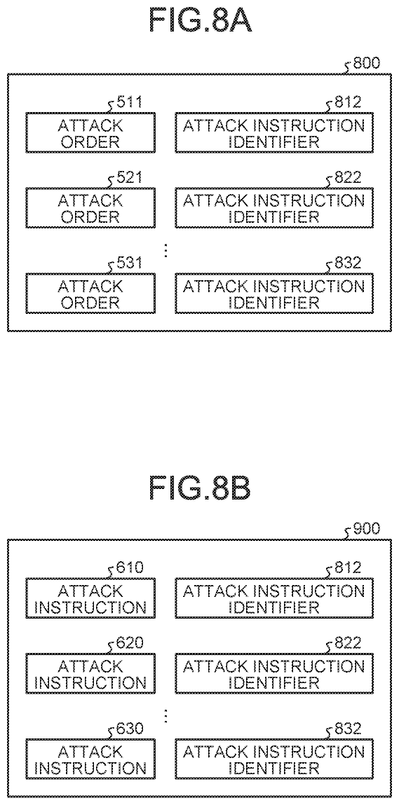

FIG. 8A is a diagram illustrating an example of a second attack scenario 800 of the second embodiment. The second attack scenario 800 of the second embodiment includes attack order 511, 521, and 531 and attack instruction identifiers 812, 822, and 832.

The attack order 511 indicates the order in which the attack instruction 610 identified by the attack in identifier 812 is executed. The attack order 521 indicates the order in which the attack instruction 620 identified by the attack instruction identifier 822 is executed. The attack order 531 indicates the order in which the attack instruction 630 identified by the attack instruction identifier 832 is executed.

Note that information indicating the dependence between attacks does not have to be the attack order 511, 521, and 531, but may be a list of attack to be executed in advance in order to execute an attack.

Since the dependence storage control unit 170 stores the dependence between attacks in the storage device, the attack instruction unit 130 can determine the attack that needs to be traced back when re-executing the attack. When a plurality of attack scenarios 500 exists, the dependence storage control unit 170 can generate a new attack scenario including a combination of new attacks as the second attack scenario 800.

FIG. 8B a diagram illustrating an example of an attack instruction group 900 of the second embodiment. The attack instruction group 900 of the second embodiment includes the attack instructions 610, 620, and 630 and the attack instruction identifiers 812, 822, and 832. The attack instruction 610 is an attack instruction identified by the attack instruction identifier 812. The attack instruction 620 is an attack instruction identified by the attack instruction identifier 822. The attack instruction 630 is an attack instruction identified by the attack instruction identifier 832. Since the attack instruction storage control unit 180 stores the attack instruction group 900 in the storage device, the attack instruction unit 130 can refer to the attack instruction of the attack to be re-executed, and can create the attack instruction with some parameters changed.

### Example of Attack Control Method

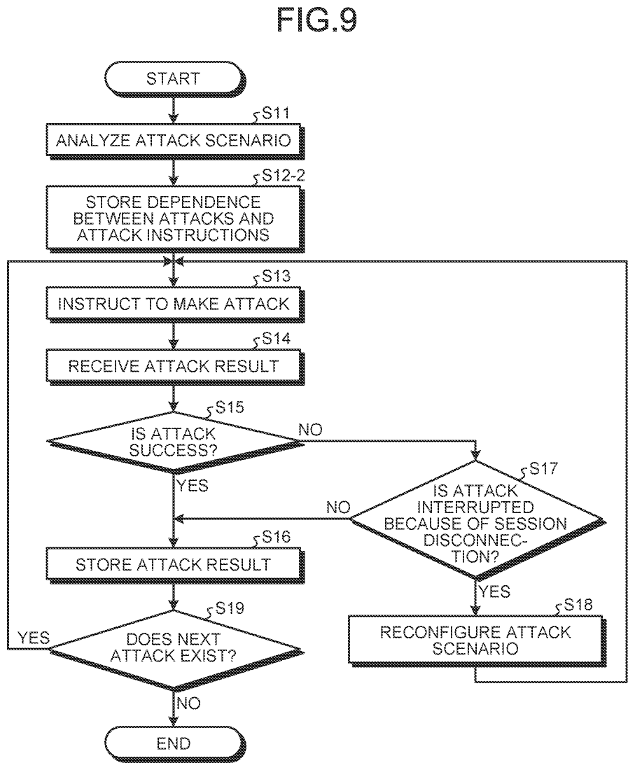

FIG. 9 is a flowchart illustrating an example of an attack control method of the second embodiment. FIG. 9 differs in that step S12 of the first embodiment (see FIG. 6) has been changed to step S12-2.

In step S12, the dependence storage control unit 170 stores the dependence between attacks in the storage device as the above-described second attack scenario 800, and the attack instruction storage control unit 180 stores the attack instruction of each attack in the storage device as the above-described attack instruction group 900. Since the second attack scenario 800 and the attack instruction group 900 are separately stored, the attack instruction unit 130 can transmit the attack scenario different from the attack scenario 500 input into the attack scenario analysis unit 110 to an attack execution device 300. The attack instruction unit 130 can refer to the attack order 511, 521, and 531 of the second attack scenario 800 and the attack instructions 610, 620, and 630 of the attack instruction group 900 as needed by using the attack instruction identifiers 812, 822, and 832.

### Third Embodiment

Next, a third embodiment will be described. In the description of the third embodiment, the description similar to the second embodiment will be omitted, and parts different from the first embodiment will be described.

### Example of Device Configuration

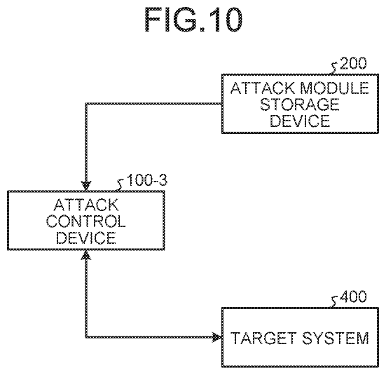

FIG. 10 is a diagram illustrating an example of a device configuration of the third embodiment. In the third embodiment, an attack control device 100-3 also has functions of the attack execution device 300 of the second embodiment. An attack module storage device 200 and a target system 400 are similar to those in the second embodiment, and thus the description thereof is omitted.

The attack control device 100-3 receives one or more attack scenarios 500 from an external device and refers to an attack module of the attack module storage device 200. Then, the attack control device 100-3 performs communication for cyber attack resistance evaluation on the target system 400 (communication related to the attack by the attack module) and evaluates the attack resistance of the target system 400.

Note that the attack module storage device 200 may be built in the attack control device 100.

### Functional Configuration

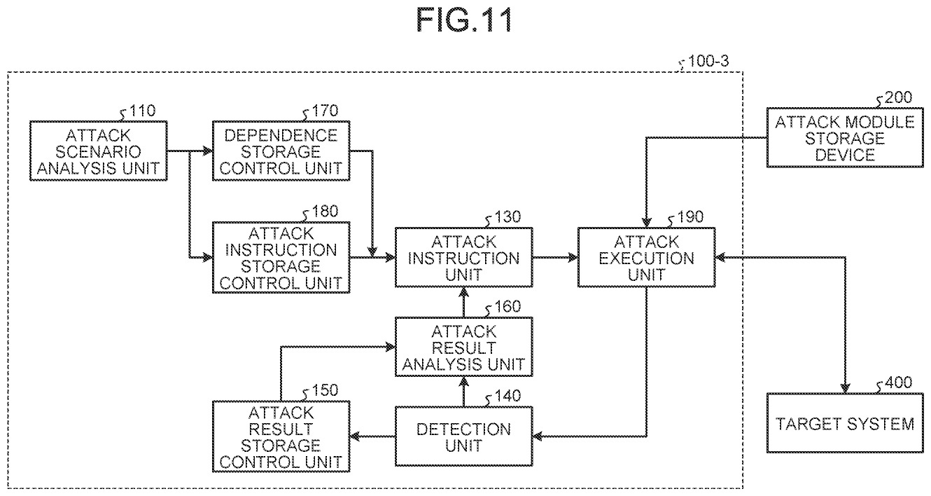

FIG. 11 is a diagram illustrating an example of a functional configuration of the attack control device 100-3 of the third embodiment. The attack control device 100-3 of the third embodiment includes an attack scenario analysis unit 110, an attack instruction unit 130, a detection unit 140, an attack result storage control unit 150, an attack result analysis unit 160, a dependence storage control unit 170, an attack instruction storage control unit 180, and an attack execution unit 190.

The attack scenario analysis unit 110, the attack instruction unit 130, the detection unit 140, the attack result storage control unit 150, the attack result analysis unit 160, the dependence storage control unit 170, and the attack instruction storage control unit 180 are similar to those in the second embodiment, and thus the description thereof will be omitted.

For example, upon receiving an attack instruction 610 from the attack instruction unit 130, the attack execution unit 190 refers to the attack module of the attack module storage device 200 by using attack module information 512 included in the attack instruction 610. Then, the attack execution unit 190 sets a plurality of parameters 513 included in the attack instruction 610 to the attack module, and executes the attack on the target system 400.

Note that the attack instruction 610 does not necessarily have to include the parameters 513. When the attack instruction 610 does not include the parameters 513, the attack execution unit 190 may separately execute an attack instruction to collect information for setting values of the parameters 513, and set the values acquired by the attack instruction to the parameters 513 in the attack module. Specifically, for example, the attack execution unit 190 may newly execute a host scan attack instruction and set the acquired IP address as a parameter for the next attack instruction. For example, the attack execution unit 190 may newly execute an attack instruction of brute force attack with a password, and set the revealed password to the parameter for the next attack instruction.

### Example of Attack Control Method

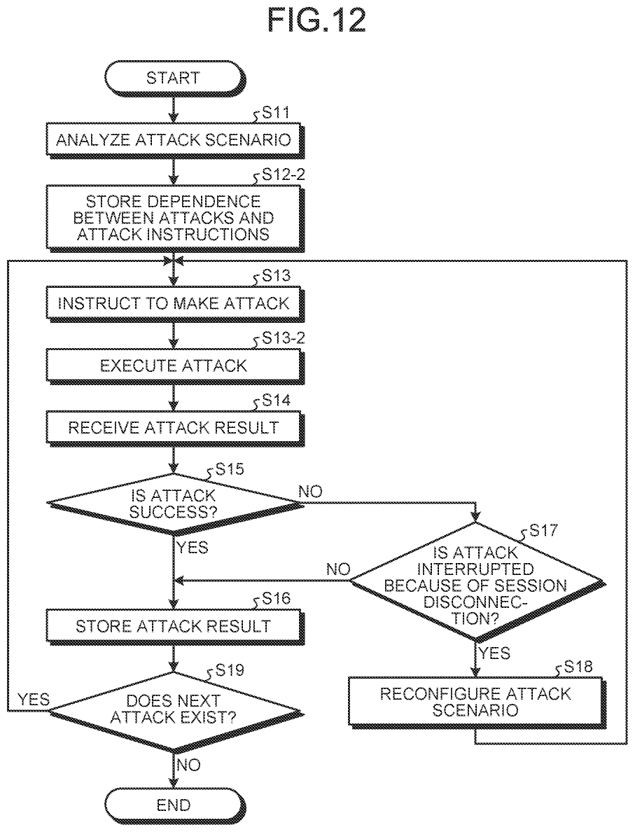

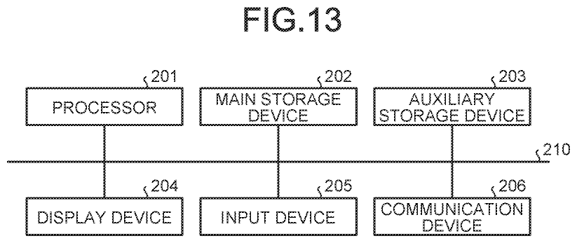

FIG. 12 is a flowchart illustrating an example of an attack control method of the third embodiment. FIG. 12 differs in that step S13-2 is added to the flowchart of the attack control method of the second embodiment (see FIG. 9).

In step S13-2, the attack execution unit 190 executes the attack on the target system 400. The attack executed in step S13-2 is, for example, an attack aiming at known vulnerability. The known vulnerability that may be a target of the attack includes vulnerability that enables execution of an arbitrary code, vulnerability that enables privilege escalation, and vulnerability that enables acquisition, tampering, or deletion of authentication information and confidential information.

For example, the attack executed in step S13-2 is an attack to transmit data obtained by modifying part of normal communication data such as fuzzing. For example, the attack executed in step S13-2 is an attack to replace a normal communication sequence, change timing, or perform transmission with some communication data skipped. For example, the attack executed in step S13-2 may be an attack by remote access communication such as RDP, SSH, or Telnet, and may be an attack to transmit a large number of requests in a short time, such as a SYN flood attack.

The attack execution unit 190 generates an attack result group 700 based on a response of the target system 400 to the attack communication transmitted in step S13-2 (step S14), and transmits the attack result group 700 to the detection unit 140.

In the third embodiment, the attack result can include arbitrary elements, and therefore session information generated or disconnected for each attack instruction can be recorded. This allows the attack execution unit 190, when re-executing the attack or when executing another attack scenario, to preferentially execute the attack instruction with a successful attack.

Finally, an example of a hardware configuration of the attack control device 100 (100-2, 100-3) of the first to third embodiments will be described.

### Example of Hardware Configuration

FIG. 11 is a diagram illustrating an example of the hardware configuration of the attack control device 100 (100-2, 100-3) of the first to third embodiments. The attack control device 100 (100-2, 100-3) of the first to third embodiments includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected to each other via a bus 210.

Note that the attack control device 100 (100-2, 100-3) may not include part of the above-described configuration. For example, when the attack control device 100 (100-2, 100-3) can use input and display functions of an external device, the attack control device 100 (100-2, 100-3) may not include the display device 204 and the input device 205.

The processor 201 executes a program read from the auxiliary storage device 203 to the main storage device 202. The main storage device 202 is a memory such as a ROM and RAM. The auxiliary storage device 203 is a hard disk drive (HDD), a memory card, and the like.

The display device 204 is, for example, a liquid crystal display or the like. The input device 205 is an interface for operating the attack control device 100. Note that the display device 204 and the input device 205 may be implemented by a touch panel or the like having a display function and an input function. The communication device 206 is an interface for communicating with other devices.

The program executed by the attack control device 100 (100-2, 100-3) is a file in an installable or executable format, and is recorded in a computer-readable storage medium such as a CD-ROM, memory, card, CD-R, and DVD and is provided as a computer program product.

A configuration may be adopted such that the program executed by the attack control device 100 (100-2, 100-3) is stored in a computer connected to a network such as the Internet and is provided by downloading via the network. A configuration may be adopted such that the program executed by the attack control device 100 (100-2, 100-3) is provided via a network such as the Internet without downloading.

A configuration may be adopted such that the program of the attack control device 100 (100-2, 100-3) is provided by being incorporated into a ROM or the like in advance.

The program executed by the attack control device 100 (100-2, 100-3) has a module configuration including functions that can be implemented by the program out of the functional configuration of FIG. 2 (FIG. 7, FIG. 11) described above. As actual hardware of each of the functions, the processor 201 reads and executes the program from a storage medium, whereby each of the functional blocks is loaded on the main storage device 202. That is, each of the functional blocks is generated on the main storage device 202.

Note that part or all of the functions of FIG. 2 (FIG. 7, FIG. 11) described above may not be implemented by software, but may be implemented by hardware such as an IC.

Each function may be implemented by using a plurality of processors 201, and in this case, each processor 201 may implement one of the functions, or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An attack control device comprising:
a detection unit that analyzes an attack result of a multi-stage attack executed based on an attack scenario and detects a failed attack instruction that has failed because of a session interrupted during the multi-stage attack;
an attack result storage control unit that stores the attack result in a storage device;
an attack result analysis unit that analyzes an attack instruction that has established the interrupted session from the attack result; and
an attack instruction unit that resumes the multi-stage attack from the attack instruction that has established the interrupted session.

2. The device according to claim 1, wherein
the attack scenario includes a plurality of attack instructions and dependence between the plurality of attack instructions,
the attack control device further comprises an attack scenario storage control unit that stores the attack scenario in the storage device, and
based on the dependence, the attack instruction unit goes back to the attack instruction that has established the interrupted session and resumes the multi-stage attack from the attack instruction that has established the interrupted session.

3. The device according to claim 1, further comprising:
an attack scenario analysis unit that analyzes the attack scenario and acquires a plurality of attack instructions and dependence between the plurality of attack instructions;
an attack instruction storage control unit that stores the plurality of attack instructions in the storage device; and
a dependence storage control unit that stores the dependence in the storage device,
wherein based on the dependence, the attack instruction unit goes back to the attack instruction that has established the interrupted session and resumes the multi-stage attack from the attack instruction that has established the interrupted session.

4. The device according to claim 1, wherein
the attack result includes success or failure of the attack instruction,
the attack result analysis unit analyzes an attack instruction that is more likely to succeed, based on the success or failure of the attack instruction, and
the attack instruction unit instructs attacks by preferentially using an attack scenario including the attack instruction more likely to succeed, more.

5. The device according to claim 1, wherein
the attack result analysis unit analyzes an attack instruction that is less likely to fail because of the session, based on the failed attack instruction, and
the attack instruction unit in attacks by preferentially using an attack scenario including the attack instruction less likely to fail because of the session, more.

6. The device according to claim 1, wherein
when re-executing the failed attack instruction, in a case where an available session has already been established, the attack instruction unit uses the available session.

7. The device according to claim 1, wherein
the attack result analysis unit determines whether a number of times the failed attack instruction is detected is greater than a threshold or not, and
when the number of times the failed attack instruction is detected is greater than the threshold, the attack instruction unit instructs attacks based on an attack scenario that does not include the failed attack instruction.

8. The device according to claim 1, further comprising
an attack execution unit that executes attacks based on attack instructions from the attack instruction unit.

9. An attack control system comprising:
an attack control device; and
an attack execution device, wherein
the attack control device includes:
a detection unit that analyzes an attack result of a multi-stage attack executed based on an attack scenario and detects a failed attack instruction that has failed because of a session interrupted during the multi-stage attack;
an attack result storage control unit that stores the attack result in a storage device;
an attack result analysis unit that analyzes an attack instruction that has established the interrupted session from the attack result; and
an attack instruction unit that resumes the multi-stage attack from the attack in that has established the interrupted session, and
the attack execution device executes attacks based on attack instructions from the attack instruction unit.

10. A computer program product comprising a computer-readable medium including programmed instructions, the instructions causing a computer to function as:
a detection unit that analyzes an attack result of a multi-stage attack executed based on an attack scenario and detects a failed attack instruction that has failed because of a session interrupted during the multi-stage attack;
an attack result storage control unit that stores the attack result in a storage device;
an attack result analysis unit that analyzes an attack instruction that has established the interrupted session from the attack result; and
an attack instruction unit that resumes the multi-stage attack from the attack instruction that has established the interrupted session.
